(19) United States
(12) Patent Application Publication
(10) Pub. No.: US 2022/0132949 A1
(43) Pub. Date: May 5, 2022

(54) NASAL MASK

(71) Applicant: GA INTERNATIONAL, Laval (CA)

(72) Inventor: Gourgen AMBARTSOUMIAN, Laval (CA)

(21) Appl. No.: 17/437,898

(22) PCT Filed: Mar. 12, 2020
(86) PCT No.: PCT/CA2020/050330

§ 371 Date: Sep. 10, 2021

Related U.S. Application Data
(60) Provisional application No. 62/817,137, filed on Mar. 12, 2019.

(51) Int. Cl. A41D 13/11; A62B 23/06; A62B 23/02; A62B 18/02

(52) U.S. Cl. CPC A41D 13/1115; A41D 13/1161; A62B 18/025; A62B 23/025; A62B 23/06

(57) ABSTRACT

A nasal mask comprises a panel of breathable filter material, the panel having a bottom edge and a top edge, a height between the bottom edge and the top edge being between approximately 40 and 80 mm. The panel is configured to cover a portion of the face extending from under a nasal bridge to an upper lip of a wearer, a shapeable strip connected to the panel at or adjacent to the bottom edge of the panel, the shapeable strip being configured to be applied against an upper lip with the bottom edge of the panel being above a mouth cavity of the wearer.

### CROSS-REFERENCE TO RELATED APPLICATION

The present application claims the priority of U.S. Patent Application No. 62/817,137, the contents of which are incorporated herein by reference.

### TECHNICAL FIELD

The application relates to dust masks used in specific applications such as in dentistry, among other contemplated uses.

### BACKGROUND

Dust masks are conventionally used for some activities, such as construction, renovation, cleaning. Dusts masks may consist of a flexible panel held over the nose and mouth by elastic straps to protect against airborne particles, such as dust. The flexible panel is made of a breathable material that acts as a filter to block airborne particles from accessing the respiratory tract. Dust masks may also be used as protection against allergens. Conventional dust masks are sized so as to cover both the nose and the mouth.

In some circumstances, such dust masks cannot be used. For example, in dentistry, patients are required to have the oral cavity wide open, whereby dust masks cannot be used. However, some types of dental treatments result in the creation of airborne particles, notably in dental restoration, in which dental burrs or like power tools are used. Such dental treatment may involve grinding and/or polishing composite materials used as fillings. Such procedures may cause a release of respirable aerosolized dust composed of various size of particles, e.g. nano-sized to 1-5 μm or bigger. The dust may consist of various composite materials, such as quartz-containing composites, nano-hybrid composites, conventional hybrid composites. The release of the dust from various composite materials in a close proximity to nasal cavities may end up in the patient's respiratory tract.

### SUMMARY

In one aspect, there is provided a nasal mask comprising a panel of breathable filter material, the panel having a bottom edge and a top edge, a height between the bottom edge and the top edge being between approximately 40 and 80 mm, whereby the panel is configured to cover a portion of the face extending from under a nasal bridge to an upper lip of a wearer, a shapeable strip connected to the panel at or adjacent to the bottom edge of the panel, the shapeable strip being configured to be applied against an upper lip with the bottom edge of the panel being above a mouth cavity of the wearer.

Further in accordance with the aspect, for instance, the panel has folds between the bottom edge and the top edge to define an expandable portion to increase the height.

Still further in accordance with the aspect, for instance, the expandable portion is in a central portion of the panel, with lateral portions being without height expansion capacity.

Still further in accordance with the aspect, for instance, the folds are horizontal.

Still further in accordance with the aspect, for instance, at least one attachment strap is connected to the panel.

Still further in accordance with the aspect, for instance, the at least one attachment strap includes elastic loops projecting from lateral edges of the panel.

Still further in accordance with the aspect, for instance, another shapeable strip is connected to the panel at or adjacent to the top edge of the panel, the shapeable strip being configured to be applied against a nose dorsum.

Still further in accordance with the aspect, for instance, the shapeable strip is located on an inner surface or outer surface of the panel or encapsulated in the panel.

Still further in accordance with the aspect, for instance, a length of the panel is from 40 mm to 200 mm.

Still further in accordance with the aspect, for instance, the panel is made of at least one layer having a porosity for blocking particles 50 μm or more in size.

Still further in accordance with the aspect, for instance, the panel is made of at least one layer having a porosity for blocking particles 30 μm or more in size.

Still further in accordance with the aspect, for instance, the panel is made of at least one layer having a porosity for blocking particles 10 μm or more in size.

Still further in accordance with the aspect, for instance, the panel is made of at least one layer having a porosity for blocking particles 5 μm or more in size.

Still further in accordance with the aspect, for instance, the panel is made of at least one layer having a porosity for blocking particles 2 μm or more in size.

Still further in accordance with the aspect, for instance, the panel is made of at least one layer having a porosity for blocking particles 0.2 μm or more in size.

Still further in accordance with the aspect, for instance, the panel is made of at least one layer having a porosity for blocking particles 0.05 μm or more in size.

Still further in accordance with the aspect, for instance, the panel is made of one or more layers of materials selected from a group including: spun-bond polypropylene, fibers of cellulose, polyester, blends of cellulose and polyester fibers, microfibers, nanomaterials, or any combination thereof.

Still further in accordance with the aspect, for instance, the panel is may include melt-blown, non-woven fabrics, and/or activated carbon.

Still further in accordance with the aspect, for instance, a see-through visor projects from the top edge of the panel and is configured to eyes of the wearer when the nasal mask is worn.

In accordance with another aspect, there is provided a nasal mask comprising a shell of breathable filter material, the shell having a bottom edge and a top edge, a height between the bottom edge and the top edge being between approximately 40 and 80 mm, the shell defining a cavity configured to cover a portion of the face extending from under a nasal bridge to an upper lip of a wearer and receive a nose, a breathing valve mounted onto the shell for breathing through, and at least one attachment strap projecting laterally from the shell.

Further in accordance with the other aspect, for instance, a shapeable strip is connected to the shell at or adjacent to the bottom edge of the shell, the shapeable strip being configured to be applied against an upper lip with the bottom edge of the shell being above a mouth cavity of the wearer.

Still further in accordance with the other aspect, for instance, the at least one attachment strap includes elastic loops projecting from lateral edges of the shell.

Still further in accordance with the other aspect, for instance, another shapeable strip is connected to the shell at or adjacent to the top edge of the shell, the shapeable strip being configured to be applied against a nose dorsum.

Still further in accordance with the other aspect, for instance, the shapeable strip is located on an inner surface or outer surface of the shell or encapsulated in the shell.

Still further in accordance with the other aspect, for instance, a length of the shell is from approximately 40 mm to 200 mm.

Still further in accordance with the other aspect, for instance, a see-through visor projects from the top edge of the shell and is configured to eyes of the wearer when the nasal mask is worn.

### DESCRIPTION OF THE DRAWINGS

Reference is now made to the accompanying figures in which:

FIGS. 1A to 1D are perspective views showing a nasal mask of an embodiment of the present disclosure as used on a patient; and

FIGS. 2A to 2E are perspective views showing a nasal mask of another embodiment of the present disclosure as used on a patient;

FIG. 3 is a schematic sectional view of the nasal mask of FIG. 1; and

FIG. 4 shows various contemplated constructions for the nasal masks of the present disclosure.

### DETAILED DESCRIPTION

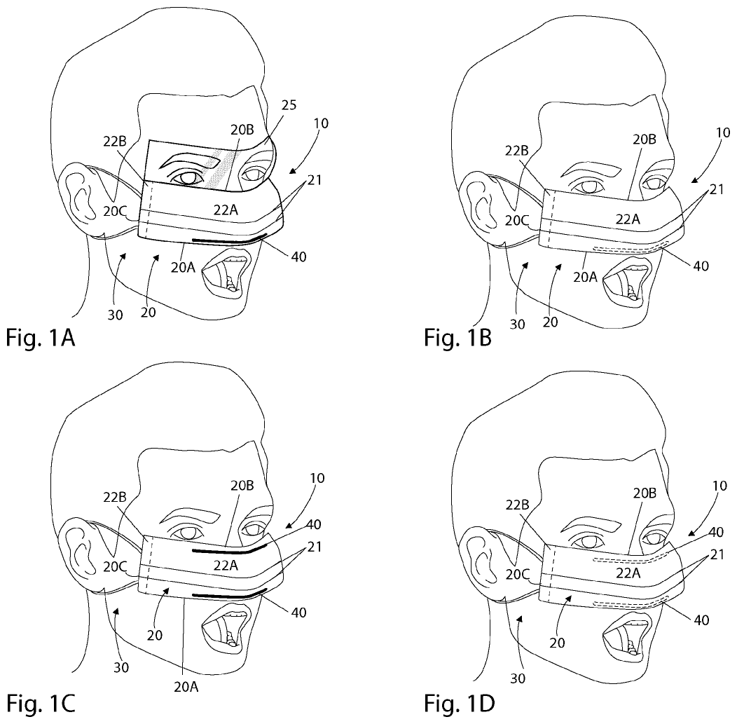

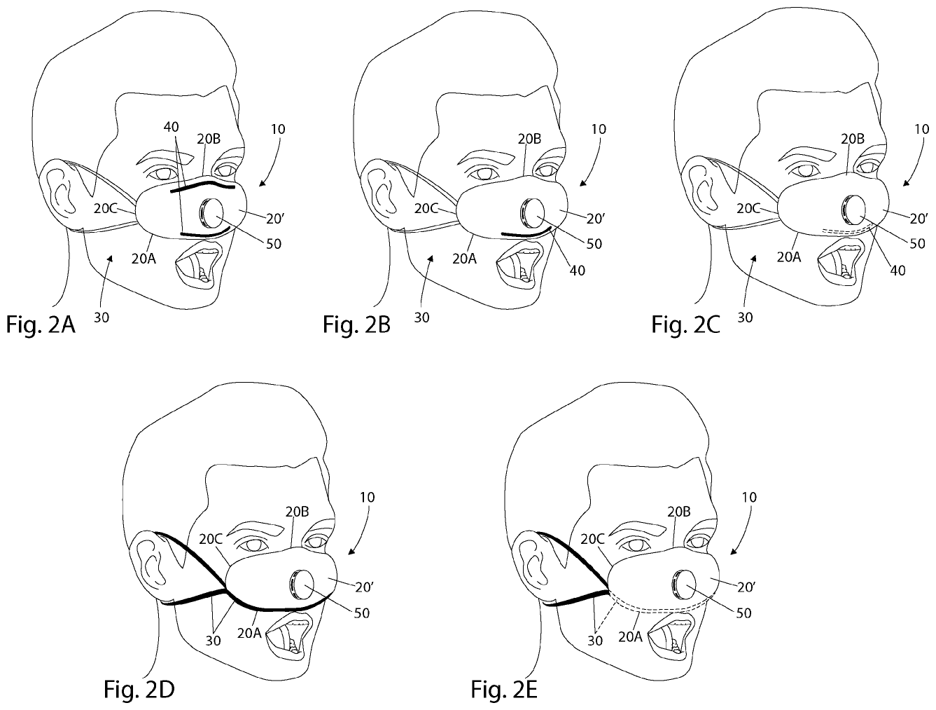

Referring to the drawings, there is shown at 10 a nasal mask in accordance with the present disclosure. According to an embodiment, the nasal mask 10 has a panel 20 or shell 20′, attachment strap(s) 30, and a shapeable strip 40:
The panel 20 is a breathe-through membrane blocking airborne particles from reaching the nasal airways. The panel 20 is shown for instance in FIGS. 1A to 1D. Alternatively, the nasal mask 10 may have a shell 20′ is shown in FIGS. 2A to 2E.
The attachment strap(s) 30 temporarily attach and hold the panel 20/shell 20′ to the face to cover the regions of the face described above.
The shapeable strip 40 is used to ensure that the nostrils are covered by the panel 20 or shell 20′.
A breathing valve 50 may be present in the nasal mask 10, such as the versions of the mask 10 having the shell 20′.

The panel 20 is shown generally rectangular in FIGS. 1A to 1D, though other shapes are contemplated. The panel 20 is shaped and sized to cover part of the human face, such as parts of the nose including the nostrils and the dorsum (e.g., from under the nasal bridge as shown), part of the upper lip and philtrum. The panel 20 may generally extend laterally beyond the nasolabial fold to cover part of the cheeks. A bottom edge 20A of the panel 20 is above the open mouth cavity such that the panel 20 in use does not cover the mouth cavity. A top edge 20B is below the eyes of the patient, so as not to obstruct the vision of the patient, e.g., under the nasal bridge. Accordingly, for an adult patient, the height for the panel 20 may range from approximately 40 to 80 mm, i.e., from the bottom edge 20A to the top edge 20B, without taking any folds into consideration. A length of the panel 20, for an adult patient, may range from approximately 40 to 200 mm, i.e., from one lateral edge 20C to another. This is merely given as an example as the height and/or length may be outside of these dimensions.

The panel 20 is made of a breathe-through material allowing air passage, but acting as a filter against the passage of some airborne particles. For example, materials that may be used to make up the panel 20 include one or more layers of, materials such as spun-bond polypropylene, fibers of cellulose, polyester or various blends of cellulose and polyester fibers, microfibers, nanomaterials, or any combination thereof. The layers may comprise melt-blown and/or non-woven fabrics, among possibilities. The above-list is non-exhaustive and may include other materials provided the materials are breathe-through and filtering. The panel 20 may come in various colors, and some printing may be present on the panel 20, such as a company logo.

The constitution of the panel 20 may be dependent on the filtering capacity and/or the airborne particles to which a user is exposed. In an embodiment, the nasal mask 10 has a material for the panel 20 having a porosity for blocking particles 50 μm or more in size. In another embodiment, the material for the panel 20 is selected to block particles 30 μm or more in size. In another embodiment, the material for the panel 20 is selected to block particles 10 μm or more in size. In another embodiment, the material for the panel 20 is selected to block particles 5 μm or more in size. In another embodiment, the material for the panel 20 is selected to block particles 2 μm or more in size. In another embodiment, the material for the panel 20 is selected to block particles 0.2 μm or more in size. In another embodiment, the material for the panel 20 is selected to block particles 0.05 μm or more in size. In another embodiment, the material for the panel 20 is selected block nano-size particles. To achieve such filtration, the panel 20 may be made of numerous layers. For example, a first layer of the panel 20 may stop 10 μm particles and a second layer 2 μm particles. In another example, the panel 20 may have two or more layers that can each filter 5 μm particles. The panel 20 may be or may include a HEPA filter layer.

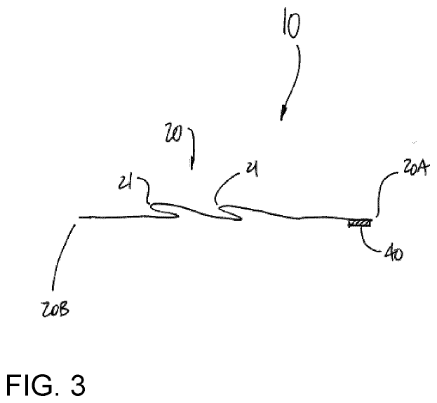

As shown in FIGS. 1A-1D and 3, a particular embodiment of the nasal mask 10 features fold(s) 21 of the panel 20. There may be one or more folds 21, extending for example from lateral edge to lateral edge, as shown. The folds 21 may be limited to a central section 22A of the panel 20, with lateral sections 22B not having such folds 21. As another possibility, the folds 21 are present, but are secured together so as not to unfold at the lateral edges. The lateral sections 22B may be limited to strips at the lateral edges 20C, and may be for example stitches, a laminated cover, etc. preserving locally the height of the panel 20. The folds 21 allow a local increase of the height, i.e., the distance between the bottom edge 20A and the top edge 20B. Indeed, as the nose is a protuberance of various sizes, the folds 21 may be ensure to release panel material, for the panel 20 to accommodate various nasal anatomies. The folds 21 are oriented in such a way that fold lines are generally parallel to the bottom edge 20A and/or the top edge 20B, or otherwise spaced apart from and non-intersecting with the edges 20A and 20B. This orientation allows a height-wise expansion. Although the folds 21 are shown as defining material overlaps, the folds 21 may have different shapes, such as accordion folds in any orientation.

In another embodiment, there are no folds 21. The height of the panel 20 is selected to have sufficient material to cover larger noses and surrounding facial features as described above. For example, in an embodiment, the height of the panel 20 varies, from a smaller height at the sides, to a greater height centrally. The attachment straps 30 may then serve to taper the panel 20 at the lateral edges 20C. Moreover, in another embodiment, the nasal mask 10 may come in various sizes, with a nasal mask size being selected as a function of the anatomical features of a user or patient.

Referring to FIG. 1A, in an embodiment, a clear plastic visor 25 may be present, and may project from the top edge 20B of the panel 20, so as to cover the eyes of the wearer, and protect same from dust particles. The clear or transparent visor is made of a polymer or a plastic, for example. The visor 25 is connected in any appropriate way to the panel 20, such as by stitching, laminating, etc. Although the visor 25 is only shown in one of the figures, it may be present in any one of the nasal mask configurations of FIGS. 1A-1D and 2A-2E, including with the shell 20′.

Referring to FIGS. 1A-1D, the nasal mask 10 has an attachment strap 30. The attachment strap 30 may be a single attachment strap 30, in the form of a loop attached at its opposed ends to the panel 20, with another similar attachment strap 30 hidden by the point of view. In an embodiment, a first end of the loop is connected to an intersection between the bottom edge 20A and the lateral edge 20C of the panel 20, and a second end of the loop is connected to an intersection between the top edge 20B and the lateral edge 20C of the panel 20. Other locations are contemplated as well. The loop of the attachment strap 30 may be wrapped around a user's ear. In an embodiment, for the panel 20 to be held taut against the user, as in FIGS. 1A to 1D, the attachment straps 30 are made of an elastic material such as to exert a pull on the panel 20. Accordingly, the attachment straps 30 may be made of elastic materials, such as polymers and/or rubbers. In another embodiment, the attachment straps 30 may be laces that may be tied to proper loop length to maintain the panel 20 taut. In another embodiment, the attachment straps 30 may be complementary Velcro® strips that may be tied to proper loop length to maintain the panel 20 taut. A mirror image of the arrangement seen in FIGS. 1A to 1D may be present on the other side of the panel 20.

In some variations, the attachment straps 30 may extend around the user's head instead of being attachable to a user's ears. In such an arrangement, there may be an upper attachment strap 30 and a lower attachment strap 30. In another embodiment, the straps 30 extend along the bottom edge 20A and/or the top edge 20B. Therefore, if the bottom edge 20A and/or the top edge 20B is/are elasticized, the resilient forces may assist in keeping the bottom edge 20A and/or the top edge 20B against the user's face. In an embodiment, both attachment straps 30 are ear loops made of a single elastic band extending along the bottom edge 20A and the top edge 20B. The attachment strap(s) 30 may be secured to the panel 20 in any appropriate way, including stitching, threading, gluing, to name a few possibilities.

In an embodiment, the nasal mask 10 may be without the attachment straps 30, with a removable medical adhesive used instead to secure the mask 10 against the skin of the user.

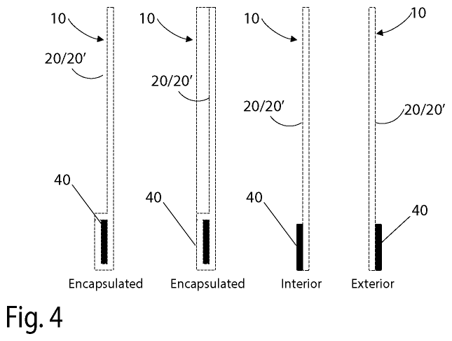

Referring to FIGS. 1A-1D and 3, one or more shapeable strips 40 (a.k.a., malleable strips) may be present. In the illustrated embodiment, a single shapeable strip 40 is present, and is adjacent to or at the bottom edge 20A (FIGS. 1A and 1B). Another such shapeable strip 40 may be adjacent to or at the top edge 20B (FIGS. 10 and 1D). The shapeable strip 40 is made of a material that has shapeable, i.e., that generally preserves a shape it is given. Stated differently, the shapeable strip 40 is made of a material that has no elasticity, and that plastically deforms and holds its shape. For example, the shapeable strip 40 is made of a metal strip, such as an aluminum strip, or other materials including polymer, plastic, composite materials or any combination thereof. The shapeable strip 40 may be glued onto, embedded in, wrapped into or received in a channel of the panel 20. FIG. 4 shows different arrangements of the strip 40 relative to the panel 20 or shell 20′. The strip 40 may be on an interior surface of the panel 20/shell 20′, on an exterior surface of the panel 20/shell 20′, encapsulated in the panel 20/shell 20′. In another embodiment, the panel 20 may have a non-shapeable body that conforms to the nasal anatomy. For example, the panel 20 may be thermo-formed so as to have a semi-sphere or semi-oval shape with an “L” facing an upper lip.

By having one shapeable strip 40 at or near the bottom edge 20A, the shapeable strip 40 may be manually pressed against the upper lip, for the shapeable strip 40 to adopt maintain a negative shape of the anatomical contour. Therefore, the shapeable strip 40 may prevent or preclude the presence of any gap or crease between the bottom portion of the panel 20 and the upper lip of the user. Another shapeable strip 40 may be present at or near the top edge 20B, for the mask to conform to the nasal dorsum and adjacent cheeks. As an alternative to a shapeable strip 40 at the top edge 20B, a nose piece or nose clip may be present.

Referring to FIGS. 2A to 2E, the nasal mask 10 may have the shell 20′ as an alternative embodiment, with the shell 20′ known as a respirator in some cases. The shell 20′ is of the type that maintains a three-dimensional shape that may emulate the human anatomy—stated differently, the shell 20′ defines a cavity for accommodating the nose. The shell 20′ may also have some structural integrity, notably to support the valve 50. The shell 20′ of FIGS. 2A-2E may be shaped and sized to cover part of the human face, such as parts of the nose including the nostrils and the dorsum, part of the upper lip and philtrum. Similarly to the panel 20, the shell 20′ may generally extend laterally beyond the nasolabial fold to cover part of the cheeks. A bottom edge 20A of the shell 20′ is above the open mouth cavity such that the shell 20′ in use does not cover the mouth cavity. A top edge 20B is below the eyes of the patient, so as not to obstruct the vision of the patient. Accordingly, for an adult patient, the height for the shell 20′ may range from approximately 40 to 80 mm, i.e., from the bottom edge 20A to the top edge 20B. A length of the shell 20′, for an adult patient, may range from 40 to 200 mm, i.e., from one lateral edge 20C to another. This is merely given as an example as the height and/or length may be outside of these dimensions.

The shell 20′ may be made with a material that limits particulate penetration, especially if breathable valve 50 is present. Whether with or without the valve 50, the shell 20′ could be made of a breathe-through material allowing air passage, but acting as a filter against the passage of some airborne particles. For example, materials that may be used to make up the shell 20′ include one or more layers of, materials such as spun-bond polypropylene, fibers of cellulose, polyester or various blends of cellulose and polyester fibers, microfibers, nanomaterials, or any combination thereof. The layers may comprise melt-blown and/or non-woven fabrics, activated carbon, among possibilities. Thermoforming or molding techniques may be used, such that the shell 20′ may be a thermo-formed shell or a molded shell. The above-list is non-exhaustive and may include other materials provided the materials are breathe-through and filtering. The shell 20′ may come in various colors, and some printing may be present on the shell 20′, such as a company logo.

The breathing valve 50 may be any appropriate valve that will not hamper the breathing of the user, but will filter out airborne particles during inhaling. Various constructions are possible. For example, the breathing valve 50 may be a breathing exhale valve having a durable base (e.g., plastic), elastic deformable flap at the inside (e.g. silicone or rubber) and a rigid cover (e.g., plastic). While inhaling, the flap closes tightly to ensure no particles flow into the mask. At exhaling, the flap opens up to let air go out. At the same time, the flap acts as a filter for fine particles not to enter the mask 10. The valve 50 may be used together with a filtering cartridge. The use of both exhaust and inhale valves is contemplated.

The constitution of the shell 20′ may be similar to the panel 20 and may be dependent on the filtering capacity and/or the airborne particles to which a user is exposed. In an embodiment, the nasal mask 10 has a material for the shell 20′ having a porosity for blocking particles 50 μm or more in size. In another embodiment, the material for the shell 20′ is selected to block particles 30 μm or more in size. In another embodiment, the material for the panel 20 is selected to block particles 10 μm or more in size. In another embodiment, the material for the shell 20′ is selected to block particles 5 μm or more in size. In another embodiment, the material for the shell 20′ is selected to block particles 2 μm or more in size. In another embodiment, the material for the shell 20′ is selected to block particles 0.2 μm or more in size. In another embodiment, the material for the shell 20′ is selected to block particles 0.05 μm or more in size. In another embodiment, the material for the shell 20′ is selected to block nano-size particles. To achieve such filtration, the shell 20′ may be made of numerous layers. For example, a first layer of the shell 20′ may stop 10 μm particles and a second layer 2 μm particles. In another example, the shell 20′ may have two or more layers that can each filter 5 μm particles. The shell 20′ may be or may include a HEPA filter layer.

Referring to FIGS. 2A-2E, the nasal mask 10 has an attachment strap 30. The attachment strap 30 may be a single attachment strap 30, in the form of a loop attached at its opposed ends to the shell 20′, with another similar attachment strap 30 hidden by the point of view. The loop of the attachment strap 30 may be wrapped around a user's ear. In an embodiment, for the shell 20′ to be held taut against the user, as in FIGS. 2A to 2E, the attachment straps 30 are made of an elastic material such as to exert a pull on the shell 20′. Accordingly, the attachment straps 30 may be made of elastic materials, such as polymers and/or rubbers. In another embodiment, the attachment straps 30 may be laces that may be tied to proper loop length to maintain the shell 20′ against the user's face. In another embodiment, the attachment straps 30 may be complementary Velcro® strips that may be tied to proper loop length to maintain the shell 20′ against the user's face. A mirror image of the arrangement seen in FIGS. 2A to 2E may be present on the other side of the shell 20′.

In some variations, the attachment straps 30 may extend around the user's head instead of being attachable to a user's ears. In such an arrangement, there may be an upper attachment strap 30 and a lower attachment strap 30. In another embodiment, the straps 30 extend along the bottom edge 20A and/or the top edge 20B. Therefore, if the bottom edge 20A and/or the top edge 20B is/are elasticized, the resilient forces may assist in keeping the bottom edge 20A and/or the top edge 20B against the user's face. In an embodiment, both attachment straps 30 are ear loops made of a single elastic band extending along the bottom edge 20A and the top edge 20B. The attachment strap(s) 30 may be secured to the shell 20′ in any appropriate way, including stitching, threading, gluing, to name a few possibilities.

Referring to FIGS. 2A to 2C, one or more shapeable strips 40 (a.k.a., malleable strips) may be present in the shell 20′. In the illustrated embodiment, a single shapeable strip 40 is present, and is adjacent to or at the bottom edge 20A (FIGS. 1A and 1B). Another such shapeable strip 40 may be adjacent to or at the top edge 20B (FIGS. 10 and 1D). The shapeable strip 40 is made of a material that has shapeable, i.e., that generally preserves a shape it is given. Stated differently, the shapeable strip 40 is made of a material that has no elasticity, and that plastically deforms and holds its shape. For example, the shapeable strip 40 is made of a metal strip, such as an aluminum strip or plastic strip. The shapeable strip 40 may be glued onto, embedded in, wrapped into or received in a channel of the shell 20′, as in the various embodiments of FIG. 4.

By having one shapeable strip 40 at or near the bottom edge 20A, the shapeable strip 40 may be manually pressed against the upper lip, for the shapeable strip 40 to adopt maintain a negative shape of the anatomical contour. Therefore, the shapeable strip 40 may prevent or preclude the presence of any gap or crease between the bottom portion of the panel 20 and the upper lip of the user. Another shapeable strip 40 may be present at or near the top edge 20B, for the mask to conform to the nasal dorsum and adjacent cheeks. As an alternative to a shapeable strip 40 at the top edge 20B, a nose piece or nose clip may be present. As another possibility, as shown in FIGS. 2D and 2E, the shell 20′ may be without shapeable strip 40. The nasal mask 10 of FIGS. 2D and 2E may rely on the elasticity of the attachment strap 30 to remain in contact with the face of the user, in the manner shown in FIGS. 2D and 2E. The strap 30 may be encapsulated in the shell 20′ (e.g., in a channel thereof), or may be on an inner or other surface.

Other materials that may be present may include strips or pads of a foam or like sealing materials, near the bottom edge 20A, top edge 20B and/or lateral edges 20C. Such materials may be present for the comfort of the user of the mask 10. Although other dust masks are in existence, the nasal mask 10 is designed for breathing through the nose only and not through the mouth, for instances in which the oral cavity is open with surgical/dental instruments therein. The nasal mask 10 may be provided in a non-sterile or in a sterile package, depending on the contemplated used. The nasal mask 10 may comply with NIOSH (National Institute for Occupational Safety and Health) certification, for example as a N95 filtering facepiece. Other NIOSH certified respirators N99 and N100 are also used in healthcare settings, and the nasal mask 10 may also comply with these certifications. The nasal mask 10 can be also used in non-human animals, though with different dimensions depending on the animal size and type.

1. A nasal mask comprising a panel of breathable filter material, the panel having a bottom edge and a top edge, a height between the bottom edge and the top edge being between approximately 40 and 80 mm, whereby the panel is configured to cover a portion of the face extending from under a nasal bridge to an upper lip of a wearer, a shapeable strip connected to the panel at or adjacent to the bottom edge of the panel, the shapeable strip being configured to be applied against an upper lip with the bottom edge of the panel being above a mouth cavity of the wearer.

2. The nasal mask according to claim 1, wherein the panel has folds between the bottom edge and the top edge to define an expandable portion to increase the height.

3. The nasal mask according to claim 2, wherein the expandable portion is in a central portion of the panel, with lateral portions being without height expansion capacity.

4. The nasal mask according to claim 2, wherein the folds are horizontal.

5. The nasal mask according to claim 1, further comprising at least one attachment strap.

6. The nasal mask according to claim 5, wherein the at least one attachment strap includes elastic loops projecting from lateral edges of the panel.

7. The nasal mask according to claim 1, wherein another shapeable strip is connected to the panel at or adjacent to the top edge of the panel, the shapeable strip being configured to be applied against a nose dorsum.

8. The nasal mask according to claim 1, wherein the shapeable strip is located on an inner surface or outer surface of the panel or encapsulated in the panel.

9. The nasal mask according to claim 1, wherein a length of the panel is from 40 mm to 200 mm.

10. The nasal mask according to claim 1, wherein the panel is made of at least one layer having a porosity for blocking particles 50 μm or more in size.

11. The nasal mask according to claim 1, wherein the panel is made of at least one layer having a porosity for blocking particles 30 μm or more in size.

12. The nasal mask according to claim 1, wherein the panel is made of at least one layer having a porosity for blocking particles 10 μm or more in size.

13. The nasal mask according to claim 1, wherein the panel is made of at least one layer having a porosity for blocking particles 5 μm or more in size.

14. The nasal mask according to claim 1, wherein the panel is made of at least one layer having a porosity for blocking particles 2 μm or more in size.

15. The nasal mask according to claim 1, wherein the panel is made of at least one layer having a porosity for blocking particles 0.2 μm or more in size.

16. The nasal mask according to claim 1, wherein the panel is made of at least one layer having a porosity for blocking particles 0.05 μm or more in size.

17. The nasal mask according to claim 1, wherein the panel is made of one or more layers of materials selected from a group including: spun-bond polypropylene, fibers of cellulose, polyester, blends of cellulose and polyester fibers, microfibers, nanomaterials, or any combination thereof.

18. The nasal mask according to claim 1, wherein the panel is may include melt-blown, non-woven fabrics, and/or activated carbon.

19. The nasal mask according to claim 1, wherein a see-through visor projects from the top edge of the panel and is configured to eyes of the wearer when the nasal mask is worn.

20. A nasal mask comprising a shell of breathable filter material, the shell having a bottom edge and a top edge, a height between the bottom edge and the top edge being between approximately 40 and 80 mm, the shell defining a cavity configured to cover a portion of the face extending from under a nasal bridge to an upper lip of a wearer and receive a nose, a breathing valve mounted onto the shell for breathing through, and at least one attachment strap projecting laterally from the shell.

21.-26. (canceled)
